(19) United States
(12) Patent Application Publication
(10) Pub. No.: US 2023/0172229 A1
(43) Pub. Date: Jun. 8, 2023

(54) MEAT ALTERNATIVES COMPRISING RAPESEED PROTEIN

(71) Applicant: DSM IP ASSETS B.V., Heerlen (NL)

(72) Inventors: Arjen SEIN, Echt (NL); Linda DE LANGE, Echt (NL); Barbara JACOBS, Echt (NL)

(21) Appl. No.: 17/905,752

(22) PCT Filed: Nov. 23, 2020
(86) PCT No.: PCT/EP2020/083089

§ 371 Date: Sep. 6, 2022

(30) Foreign Application Priority Data
Mar. 24, 2020 (EP) 20165208.8

(51) Int. Cl. A23J 3/26; A23J 3/22; A23J 3/14

(52) U.S. Cl. CPC A23J 3/26; A23J 3/227; A23J 3/14

(57) ABSTRACT

The invention relates to a dry extrusion process for preparing a texturized vegetable protein, to a composition comprising rapeseed protein, a legume-derived protein, and a plant-based fiber, to the use of said composition in the preparation of a meat alternative and to meat alternatives.

### FIELD OF THE INVENTION

The invention relates to a dry extrusion process for preparing a texturized vegetable protein, to a composition comprising rapeseed protein, a legume-derived protein, and a plant-based fiber, to the use of said composition in the preparation of a meat alternative and to meat alternatives.

### BACKGROUND OF THE INVENTION

Proteins are an essential element in animal and human nutrition. Meat, in the form of animal flesh and fish, are the most common sources of high protein food. The many disadvantages associated with the use of animal-derived protein for human consumption, ranging from acceptability of raising animals for consumption to the fact that such meat production is inefficient in terms of feed input to food output and carbon foot print, makes the ongoing search for improved meat alternatives one of the most active developments in present day society.

Historically, meat alternatives achieve a certain protein content using vegetable sources such as soy (e.g. tofu, tempeh) or gluten/wheat (e.g. seitan). Today, modern techniques are used to make meat alternatives with more meat-like texture, flavor and appearance. Soy and gluten are favorable sources for such meat alternatives because they are widely available, affordable, relatively high in protein and well processable. In combination with the right technology, the formation of fibers is facilitated in soy or soy/gluten-based compositions, which is an aspect that is key for approaching the fibrous structure of animal meat. These properties as found when using soy or wheat or soy/gluten mixtures are generally not found in other plant-based proteins. Simultaneously however, there also is a strong driver to avoid soy and gluten for reasons of allergenicity and/or consumer trust. Manufacturers of meat alternatives turn to other proteins, for example like those derived from legumes, e.g. pea, fava bean, lupin, chickpea. However, use of these alternative protein sources is accompanied with new problems. The protein mixtures are often not as easily processible as the traditional soy or gluten or their combinations, and in many cases also lead to texturized food proteins that do not mimic the nutrition, texture, appearance, and/or the taste of animal-derived meat products. As a result, consumers typically consider such meat alternatives unappealing and unpalatable.

The majority of meat alternatives are made from solid plant-based materials produced by extrusion. Commonly, two types of extrusion are distinguished, high moisture (or wet) extrusion and dry extrusion.

The problem of poor texture, notably lack of fibrous texture, may be addressed by using high-moisture extrusion, leading to products with a highly fibrous nature, such as for example described in WO 2015/020873 for proteins that may be animal or plant-derived, or in WO 2019/143859 for compositions comprising two or more plant-based proteins that are not soy and do not contain gluten. Generally, in high-moisture extrusion, a water level of from 40 to 70% on the total extruder feed is used. In the process a blend of solids is fed into the extruder, water is added, and the material is kneaded into a homogeneous mass. A melt is formed at elevated temperature and pressure, which is fed into a cooling die where controlled cooling under flow leads to fibrous nature of the material. This material can be described as anisotropic, i.e. the properties and microstructure of the material are not the same in all three dimensions. Such anisotropic, fibrous material is clearly discernable while eating the product, and is generally linked to meat-like textures that are often also fibrous and anisotropic.

The problem of poor processability of certain alternative protein sources is a drawback that is most manifest in another technology used in the preparation of meat alternatives, namely dry extrusion. Dry extrusion is the preferred technology as it is cost effective, simple and robust, proven for decades and leads to material that can be used in meat alternatives with a relatively homogeneous texture, having a more isotropic character. Dry extrusion is used to make so-called texturized vegetable protein (TVP), which is material that forms the base of the largest categories of meat alternatives such as burgers, (“meat”) balls, breaded products such as nuggets alternatives or schnitzel alternatives, minced beef, minced chicken, minced pork, minced veal, (stir-fry) pieces, sausages and the like. Advantageously, dry extrusion leads to products with a low moisture content that are less susceptible to microbiological contamination due to the low water activity.

Unfortunately, dry extrusion of proteins from legumes or pulses like pea leads to difficulties in processing such as in-homogeneous extruder melts as well as in-homogeneous expansion when the extrudates leave the extruder. And upon hydration of the resulting dry extruded products to make final products, the hydrated material is too soft, highly inhomogeneous, and does not have the typical ‘bite’ that is required for meat alternatives. There is a need for legume-derived protein compositions and dry extrusion processing of such compositions that do not have the problem of poor processability.

### DETAILED DESCRIPTION OF THE INVENTION

In the context of the invention, the term “meat alternatives” also refers to meat analogue, meat substitute, mock meat, faux meat, imitation meat, vegetarian meat, fake meat, or vegan meat, and has texture, flavor, appearance or chemical characteristics of specific types of meat. Generally, meat alternative refers to food made from vegetarian ingredients, and sometimes without animal products such as dairy or egg. Meat alternatives comprises also particles that resemble minced meat, such as ground beef, ground chicken, ground pork, ground turkey, ground veal and the like. Such particles can be brought together to form meat alternatives for meat products such as beef patties, hamburgers, meat-comprising sauces such as Bolognaise sauce, minced beef, minced chicken, minced pork, minced veal, nuggets, sausages and the like.

In a first aspect, the invention provides a process for preparing a texturized vegetable protein comprising:
(a) Mixing rapeseed protein, legume-derived protein, plant-based fiber, and from 5-30% (w/w) water in an extruder,
(b) Heating the mixture obtained in step (a) to a temperature of from 100-180° C.,
(c) Extruding the mixture obtained in step (b) through an extrusion die.

In the dry extrusion process for texturized vegetable protein, a mix of plant-based proteins may be fed into an extruder such as a co-rotating twin-screw extruder, together with approximately 5-40% (w/w) water, 5-30% (w/w) water, or 10-30% (w/w) water, or 10-25% (w/w) water, or 15±10% (w/w) water. Preferably, the dry matter:water ratio in the mix is 6:1, 4:1 or 3:1 or between 6:1 to 3:1. In the context of the invention, at least one protein is derived from rapeseed and at least a second protein is legume-derived. Upon feeding to the extruder, the proteins are preferably in dry form, i.e. comprising from 0-10% (w/w) water, preferably from 0-5% (w/w) water or 3±3% (w/w) water. In an embodiment, the rapeseed protein and/or the legume-derived protein and/or the plant-based fiber may be pre-hydrated, for example in a conditioner, prior to addition to the extruder. This has as advantage that process flow and/or pumpability may be improved. Plant-based fiber is added to further improve consistency/texture and/or nutritional value and/or as a filler. Relative to the sum (on dry weight) of rapeseed protein plus legume-derived protein plus plant-based fiber, the amount of rapeseed protein may be from 2-75% (w/w), or from 5-50% (w/w), or from 10-30% (w/w), or 20±15% (w/w). Similarly, the amount of legume-derived protein may be from 10-95% (w/w), or from 20-80% (w/w), or from 40-70% (w/w), or from 45-70% (w/w), or from 50-80% (w/w), or from 50-65% (w/w) or 50±25% (w/w). Likewise, the amount of plant-based fiber may be from 2-50% (w/w), or from 5-40% (w/w), or from 15-35% (w/w) or from 20-30% (w/w), or 25±15% (w/w). The above ranges are subject to the proviso that the total sum does not exceed 100% (w/w). In addition, the blend may comprise starch and/or salt.

Rapeseed protein may be in the form of an isolate or a concentrate. Rapeseed protein isolate may be prepared from cold-pressed rapeseed oil seed meal as described in WO 2018/007492 resulting in a product with a protein content of from 50-98% (w/w), or from 70-95% (w/w) or of 90±5% (w/w). The rapeseed protein isolate may comprise of from 40-65% (w/w) cruciferins and of from 35-60% (w/w) napins as verified by Blue Native PAGE, for example as described in WO 2018/007492. Alternatively, the rapeseed protein isolate may comprise at least 80% (w/w), preferably at least 85% (w/w), preferably at least 90% (w/w), more preferably at least 95% (w/w) cruciferins as verified by Blue Native PAGE, for example as described in WO 2018/007492. Alternatively, the rapeseed protein isolate may comprise at least 80% (w/w), preferably at least 85% (w/w), preferably at least 90% (w/w), more preferably at least 95% (w/w) napins as verified by Blue Native PAGE, for example as described in WO 2018/007492.

In an embodiment the rapeseed protein isolate is low in anti-nutritional factors and contains less than 1.5% (w/w) phytate, preferably less than 0.5% (w/w) phytate, and is low in glucosinolates (<5 μmol/g) and low in phenolics (<10 mg/g). In an embodiment the rapeseed protein isolate has a high solubility, preferably in water, of at least 88% when measured over a pH range from 3 to 10. In an embodiment the rapeseed protein isolate has a low mineral content, in particular low in sodium, and with that a low conductivity when dissolved in water. This is advantageous as minimizing salt content in food products, i.e. also in meat alternatives, is an important topic in addressing improvement of public health. A well-known legume-derived protein isolate like pea protein isolate has a sodium load that is relatively high. In contrast, rapeseed protein isolate may have a conductivity in a 2 wt. % aqueous solution of less than 9 mS/cm over a pH range of 2 to 12, for example of from 0.5-9 mS/cm, or from 1-7 mS/cm or 4±3 mS/cm.

Legume-derived proteins may be for instance from lupin, pea (yellow pea, green pea), bean (such as soy bean, fava (faba) bean, kidney bean, green bean, haricot bean, pinto bean, mung bean, adzuki bean), chickpea, lupin, lentil, and peanut, and the like. Fava bean and faba bean can be used interchangeably. Advantageously, the legume-derived protein is non-allergenic. In an embodiment the protein may be in the form of a flour, a concentrated flour (obtained for example by wind sifting), a concentrate (>60% protein) or an isolate (>80% protein), or a press cake or an extracted cake. Preferably, the present legume-derived protein is chosen from the group consisting of pea protein, fava bean protein and lupin protein.

Fibers may be added to the mixture to improve the texture, and/or firmness, and/or consistency, and/or the nutritional value and/or as a filler. Examples of plant-based fiber are pea fiber fava bean fiber, lupin fiber, oil seed fiber (such as sun flower seed fiber or cotton seed fiber), fruit fiber (such as apple fiber), cereal fiber (such as oat fiber, maize fiber, rice fiber), bamboo fiber, potato fiber, inulin, or combinations thereof. Fibers are commonly present in plant-based foods and cannot (completely) be broken down by the human digestive enzymes, are either water-soluble or water-insoluble fibers. They may consist of (mixtures of) cellulose, hemicellulose, pectins and other non-starch polysaccharides or plant cell-wall biopolymers. Fiber fractions are materials that also can comprise protein, starch, lignin and/or ash.

Other components that can be added in present step (a) or to the material are starch, either native or modified (chemically or physically), from any source such as tapioca, corn, potato, pea or other legume, wheat, rice or other cereal. Next to normal salt (sodium chloride), other salts can be added, like potassium salts, calcium salts. This can be soluble or insoluble salts and minerals. Insoluble salts can also act as inert fillers and ways to change the colour of the end product. Soluble salts such as sodium bicarbonate can also be added to increase the pH during processing or in the end product. Alternatively, acids can be used to reduce the pH in during the process or in the end product. Any type of acid can be used, such as malic acid, citric acid, lactic acid, phosphoric acid, tartaric acid. Such soluble salts and pH modulators can be added as a solid to the powder premix or dissolved in the water stream. The modulation of the pH during extrusion can be used advantageously as a means to modify the texture, flavour and appearance of the TVP, it can impact on density, and on mechanical properties (dry and after hydration) such as resilience or elasticity.

Preferably, the pH of the present mix of protein powder, fiber and possibly other ingredients and water is within the range of pH 6 to 10, preferably pH 6 to 7, preferably pH 7 to 9, preferably pH 7 to 8, preferably pH 6 to 8.

In an embodiment, the mix of protein powder, fiber and possibly other ingredients and water are brought into the extruder, either separately or (partially) combined. In the extruder, the screws knead the resulting mixture into a paste. The temperature at which this takes place may be from 40-200° C., 90-190° C., or from 110-180° C., or from 120-170° C. or from 130-140° C. or at 140±30° C.

In an embodiment, the process takes place at elevated pressure such as from 5-80 bar, or from 20-60 bar or at 40±30 bar. The skilled person understands that the choice of pressure is related to the scale of the extrusion process. Preferably, the process is carried out in a continuous mode.

During the above processing, a melt is formed in the extruder, which, in an embodiment, is released through holes at the end of the extruder, where immediate expansion occurs. This expansion may be caused by water flashing off, causing next to expansion also an immediate temperature reduction, converting the melt into a ‘glassier’ type of material. In an embodiment, the stream leaving the extruder may be cut into pieces using methods known to the skilled person. Such methods may for example be a rotating knife directly at the exit of the extruder. This leads to particles of various sizes and shapes depending on the cutting mode. The latter refers to the rotation speed of the knife (which may be from 50-5000 rpm, or from 100-3000 rpm or at 1000±500 rpm), the distance between extruder head and rotating knife and the dimensions of the holes. This may lead to particles where 95% of the particles has a size of from 1-80 mm, or from 1.2-40 mm, or from 1.5-20 mm. The density for texturized vegetable proteins, preferably in the dry state, obtained according to the process of the first aspect of the invention is from 100-500 g/L, or from 200-400 g/L, or from 150-350 g/L or 300±100 g/L.

In an embodiment, the resulting particles may be further dried to a moisture content below 10% or even below 5%. Optionally the particles are milled and or sieved before or after the drying.

As outlined above, prior art texturized vegetable proteins routinely are made from soy (flours or concentrates), wheat or gluten, and quite often combinations thereof. While the molecular understanding of the phenomena occurring during extrusion is not well understood, the speculation is that gluten is responsible for special functionalities, such as elasticity during the expansion stage directly after exiting the extruder, and crosslinking by rearrangement of sulfur-sulfur bridges in the melt stage. These favorable properties are lost when the use of soy and wheat/gluten is being avoided for potential allergenicity risks. Indeed, we found that extrudates based on legume-derived proteins such as pea alone resulted in irregular flow during processing, irregular and/or inhomogeneous particles, uneven expansion and sometimes clogging of the equipment. The same applies for combinations of legume-derived proteins and fibers, for example pea protein isolate plus pea fiber. With the process of the invention, it is found that the preparation of legume-based texturized vegetable proteins by means of dry extrusion can be improved by co-processing with rapeseed protein. The process of the invention also allows for the introduction of a higher pea fiber content than is commonly used, such as from 20-40% (w/w) on dry matter.

The use of certain legume-based plant proteins has a further disadvantage with respect to nutritional profile. This can be expressed in for instance a PDCAAS value (Protein digestibility-corrected amino acid score, a method of evaluating the quality of a protein based on both the amino acid requirements of humans and their ability to digest it) and a DIAAS value (Digestible Indispensable Amino Acid Score, more a protein quality score). In pea, for example, the PDCAAS is limiting because of a low level of tryptophan and sulfur-containing amino acids. And for its DIAAS, the sulfur-containing amino acids are the first limiting amino acids to meet requirements, and the DIAAS scores of such legumes are also relatively low, 0.78 for pea concentrate for example. The limiting sulfur amino acids in legumes can be complemented by addition of rapeseed protein, a protein found to have a favorable nutritional profile (DIAAS=1.1±0.1 for adults) and to be especially rich in sulfur amino acids. By mixing legume-based plant proteins with rapeseed protein, a more complete DIAAS score can be achieved/obtained.

In a second aspect the invention provides a composition comprising rapeseed protein isolate and/or rapeseed protein concentrate and legume-derived protein isolate and/or legume-derived protein concentrate and plant-based fiber.

As in the first aspect, particles of various sizes and shapes may be obtained, depending on how cutting is executed following the extrusion. For example, particles that are useful for subsequent applications are those wherein 95% of the particles has a size of from 1-80 mm, or from 1.2-40 mm, or from 1.5-20 mm, or 6±4 mm. The density for texturized vegetable proteins obtained according to the process of the first aspect of the invention is from 100-500 g/L, or from 200-400 g/L or 300±100 g/L.

The presence of rapeseed protein isolate in the composition advantageously reduces the amount of salt compared to prior art compositions. Legume-derived proteins often contain significant amounts of sodium that is expressed as sodium chloride. For example, the amount of sodium in pea protein isolate is 3% (w/w), and when expressed as sodium chloride, the amount in pea protein isolate is 7.5% (w/w). Consequently, a prior art texturized vegetable protein comprising 80% (w/w) pea protein isolate and up to 20% (w/w) fiber contains 6% (w/w) sodium chloride on dry weight. Advantageously, the compositions of the present invention comprise less than 6% (w/w) sodium chloride, for example of from 0.1-5.5% (w/w) sodium chloride or from 1-5.5% (w/w) sodium chloride or from 2-5% (w/w) sodium chloride or from 2.5-4% (w/w) sodium chloride or 3±2% (w/w) sodium chloride on dry weight.

In an embodiment, said legume-derived protein is pea-derived protein or faba-bean derived protein, soybean-based protein, chickpea-based protein, lupin-based protein, lentil-based protein or peanut-based protein. Legume-derived proteins may be for instance from lupin, pea (yellow pea, green pea), bean (such as soy bean, fava (faba) bean, kidney bean, green bean, haricot bean, pinto bean, mung bean, adzuki bean), chickpea, lupin, lentil, and peanut, and the like. Fava bean and faba bean can be used interchangeably. Advantageously, the legume-derived protein is non-allergenic. In an embodiment the protein may be in the form of a flour, a concentrated flour (obtained for example by wind sifting), a concentrate (>60% protein) or an isolate (>80% protein), or a press cake or an extracted cake. Preferably, the present legume-derived protein is chosen from the group consisting of pea protein, fava bean protein and lupin protein.

In another embodiment said plant-based fiber is a legume-based fiber (such as pea fiber, fava bean fiber, lupin fiber, chickpea fiber), oil seed fiber (such as sun flower seed fiber or cotton seed fiber), fruit fiber (such as apple fiber), cereal fiber (such as oat fiber, maize fiber, rice fiber), bamboo fiber, potato fiber, inulin, or combinations thereof.

In a further embodiment, another source of non-animal-derived [protein-rich] material may be added to the composition such as a cereal-based, such as an oat-based, or a fungal-based, or a nut-based material.

In an embodiment, the composition does not comprise gluten or gliadin, i.e. the composition is so-called gluten-free. By gluten-free is meant that the composition comprises less than 20 ppm of gluten and more preferably less than 10 ppm of gluten. Gluten is usually measured by measuring the gliadin content, for example as described in WO 2017/102535. Therefore, according to the present invention there is provided a gluten-free composition comprising less than 10 ppm gliadin.

In another embodiment the composition does not comprise soy-derived protein. In still another embodiment the composition does not comprise gluten or gliadin and does not comprise soy-derived protein.

In a preferred embodiment, the composition comprises a ratio of cruciferin to napin in the range of from 1 cruciferin to 0.5 napin to 1 cruciferin to 1.5 napin. Alternatively, the present composition comprises a ratio of cruciferin to napin of at least 9 cruciferin to 1 napin, or comprising a ratio of cruciferin to napin of 1 cruciferin to at least 9 napin.

Preferably, the composition comprises rapeseed protein comprising of from 40-65% (w/w) cruciferins and of from 35-60% (w/w) napins of the rapeseed protein, as verified by Blue Native PAGE, for example as described in WO 2018/007492. Alternatively, the composition comprises rapeseed protein comprising at least 80% (w/w), preferably at least 85% (w/w), preferably at least 90% (w/w), more preferably at least 95% (w/w) cruciferins of the rapeseed protein, as verified by Blue Native PAGE, for example as described in WO 2018/007492. Alternatively, the composition comprises rapeseed protein comprising at least 80% (w/w), preferably at least 85% (w/w), preferably at least 90% (w/w), more preferably at least 95% (w/w) napins of the rapeseed protein, as verified by Blue Native PAGE, for example as described in WO 2018/007492.

Preferably, the present composition has a PDCAAS nutritional value of more than 0.8, preferably more than 0.85, more than 0.86, more than 0.87, more than 0.88, more than 0.89, more than 0.90, more than 0.91, more than 0.92, more than 0.93, more than 0.94 or more than 0.95. Preferably the PDCAAS is within the range of 0.8 to 1.0.

In a third aspect, the invention provides the use of a composition of the second aspect in the preparation of a meat alternative.

Texturized vegetable proteins may be applied in meat alternatives by combining the texturized vegetable protein with water. In an embodiment, final products contain from 40-80% water, or from 50-70% water. In an embodiment, other components like flavors, herbs, spices, onion pieces, oil and or (solid) fats, thickeners and so forth, may be added. Components in the meat alternative may be bound together by the addition of a gelling agent, such as egg white or methyl cellulose. The mix may be kneaded into a homogeneous mass, formed in a certain shape such as, for example, the shape of a hamburger or a chicken nugget, and subsequently set by heating at a temperature of from 60-95° C. or at 80±10° C. Optionally, for hamburger style products first a deep-frying treatment may be applied to set the outer structure. Such products can be consumed directly or after heating. In an embodiment, a reddish moist plant-derived substance is brought in the meat alternative so as to mimic the appearance of products being raw or semi-raw. These products usually don't receive an extra heat treatment during production and are stored and distributed frozen or packed under protective environment before distribution. Before consumption the consumer usually cooks the product by for instance frying in the pan, deep frying or oven treatment. In another embodiment the formed product is coated to obtain for instance a crispy outer layer, such as a breaded coating, that can be heat set by for instance deep frying or oven treatment. In another embodiment the meat alternative can be filled with another material such as a cheese or imitation cheese.

In an embodiment, the meat alternatives for which the use of the composition of the invention may be intended are beef-like patty, a nugget, (“meat”) balls, minced-style products, (stir-fry) pieces or a sausage. In another embodiment the meat alternative is the ingredient of a meal sauce, such as minced-style in a ready to use vegetarian pasta sauce like a Bolognaise sauce.

In a fourth aspect the invention provides a meat alternative comprising rapeseed protein isolate and/or rapeseed protein concentrate and legume-derived protein isolate and/or legume-derived protein concentrate and plant-based fiber. Said legume-derived protein may be a pea-derived protein and said plant-based fiber may be pea fiber. Or a fava bean protein and fava bean fiber, or lupin protein and lupin fiber and so forth, or combinations of those such as fava bean protein and pea fiber or lupin protein and pea fiber. Preferably the meat alternative does not comprise gluten or gliadin. In another embodiment the meat alternative does not comprise soy-derived protein. In still another embodiment the meat alternative does not comprise gluten or gliadin and does not comprise soy-derived protein. In still another embodiment the meat alternative does not contain animal-derived material.

In an embodiment, the meat alternative of the fourth aspect has an amount of sodium chloride that is lower than that of prior art meat alternatives based on pea protein isolate or other pulse protein isolates. Prior art meat alternatives are hydrated texturized vegetable proteins wherein the amount of water is, about twice the amount or higher of texturized vegetable proteins and these meat alternatives contain 2% (w/w) or more sodium chloride. Advantageously, the meat alternatives of the present invention comprise less than 2% (w/w) sodium chloride, for example of from 0.5-1.8% (w/w) sodium chloride or from 0.8-1.5% (w/w) sodium chloride or from 1-1.3% (w/w) sodium chloride or 1±0.5% (w/w) sodium chloride.

Preferably, the meat alternative comprises rapeseed protein comprising of from 40-65% (w/w) cruciferins and of from 35-60% (w/w) napins of the rapeseed protein, as verified by Blue Native PAGE, for example as described in WO 2018/007492. Alternatively, the meat alternative comprises rapeseed protein comprising at least 80% (w/w), preferably at least 85% (w/w), preferably at least 90% (w/w), more preferably at least 95% (w/w) cruciferins of the rapeseed protein, as verified by Blue Native PAGE, for example as described in WO 2018/007492. Alternatively, the meat alternative comprises rapeseed protein comprising at least 80% (w/w), preferably at least 85% (w/w), preferably at least 90% (w/w), more preferably at least 95% (w/w) napins of the rapeseed protein, as verified by Blue Native PAGE, for example as described in WO 2018/007492.

### EXAMPLES

### Materials and Methods

Rapeseed protein isolate (RPI) was prepared from cold-pressed rapeseed oil seed meal as described in WO 2018/007492; the protein content was 90% (w/w). The resultant RPI comprised in the range of from 40 to 65% (w/w) cruciferins and 35 to 60% (w/w) napins, contained less than 0.26% (w/w) phytate and had a solubility of at least 88% when measured over a pH range from 3 to 10 at a temperature of 23±2° C. pH measurements were carried out using a Radiometer model PHM220 pH meter equipped with a PHC3085-8 Calomel Combined pH electrode (D=5 MM).

Pea protein isolate (PPI) and pea fiber were from Cosucra, compositions as per the below Tables.

Vital wheat gluten from Kröner Starke, Ibbenbüren Germany,

Fava bean protein flour, ABM-HT 60-HT, Roland Beans Germany

Lupin protein isolate, Art. nr 10600, batch 181106, Prolupin, Grimmen, GermanyDL-Malic acid, Aldrich M0875; Sodium Bicarbonate (NaHCO₃)—baking powder (Ecoplaza, Netherlands)

TABLE
Composition of pea protein isolate, based on D.M.
95 ± 2%, fava bean flour and lupin protein

| | Pea protein | Fava bean | Lupin protein |
|---|---|---|---|
| | isolate | flour | isolate |
| Proteins | 88 ± 2% | 55-65% | 91 |
| (N × 6.25) | | | |
| Carbohydrates | Max 3.0% | 21.8% | 0.5% (all |
| | | (starch), | sugar) |
| | | 1.6% sugar | |
| Fiber | | 11.1% | 4.4% |
| Ash | Max 6.0% | 5.5-6.5% | 2.1% (as salt) |
| Fat (PE extract) | Max 1.5% | 3.8% | 3.0% (0.7 sat) |

Nutrition labeling (per 100 g)

| | |
|---|---|
| Caloric value | 348 kcal 1455 kJ |
| (Energy) | |
| Proteins | 83.6 g |
| (N × 6.25) | |
| Carbohydrates | 0.4 g (of which sugars: 0 g) |
| Fat (PE extract) | 1.3 g (of which saturated: 0.2 g) |
| Dietary fiber | 2.3 g |
| Sodium | 3.0 g |

TABLE
Composition of pea fiber

| | |
|---|---|
| Solids (%) | 90 ± 2% |
| Dietary fibers (%) | 48 ± 3% |
| Starch (%) | Min. 36% |
| Proteins (%) | Max. 7% |
| Ash (%) | Max. 2% |
| Fat (%) | Max. 0.5% |

### Example 1

### Dry Extrusion

Dry extruded material was produced on a twin-screw extruder ZSK 27 MV from Coperion GmbH. Protein powder was fed with a throughput of around 12 kg/hr using a gravimetric solid feeder into the first barrel. Water was fed with a gravimetric peristaltic pump (Watson Marlow) into the second barrel with around 2 kg/hr. The screw speed was set constant at 400 rpm, the cutting head rotated with 1200 rpm, the temperature profile in all cases was that in sections 7- and 8 (of the 10) the temperature was the highest, around 140° C., and the exit temperature was usually around 135° C. At the end of the barrel a die plate with four spherical holes of 3 mm diameter was placed. Material exiting the barrel was immediately cut into pieces by a rotating knife. A set of compositions was tested where the RPI and PF concentration was varied step by step at the expense of PPI content. In a second set of compositions, several variants were made and under food-grade production conditions. This included a variation in the type of holes in the die. The compositions are given in the below Table.

| | | | | |
|---|---|---|---|---|
| | PPI | PF | RPI | Observations on processing |
| # | (%) | (%) | (%) | and appearance of the material |

Set 1

| | | | | |
|---|---|---|---|---|
| 1 (Ref) | 80 | 20 | | Irregular flow, hard to process. Irregular |
| | | | | particles with hard non-expanded pieces |
| | | | | within, uneven expansion |
| 2 | 70 | 20 | 10 | After irregular flow at start eventually |
| | | | | produced well, lower torque than |
| | | | | reference. Reasonably good expansion |
| | | | | and fairly homogeneous particles |
| 3 | 60 | 20 | 20 | Better expansion then for sample 2, |
| | | | | smoother process, non-spherical |
| | | | | particles |
| 4 | 50 | 20 | 30 | High expansion, large, smooth and more |
| | | | | spherical particles |
| 5 | 50 | 30 | 20 | Nice spherical and homogeneous particles, |
| | | | | looks very well |

Set 2

| | | | | |
|---|---|---|---|---|
| 6 | 60 | 20 | 20 | Same as sample # 3. Extrusion went well, |
| | | | | rod-shaped particles |
| 7 | 50 | 30 | 20 | Same as sample # 5. Smooth processing. |
| | | | | Good product, spherical particles |
| 8 | 55 | 30 | 15 | Smooth processing. Good product, |
| | | | | homogeneously expanded |
| 9 | 50 | 30 | 20 | Same as samples #5 and #7; Die with |
| | | | | different orifice shape was used: two |
| | | | | holes of 15 × 1.6 mm. Produced as good |
| | | | | as sample #7, particles irregularly |
| | | | | shaped and larger than #7 |

All compositions led to texturized vegetable protein material of various nature. Observations on the ease of processing and the appearance of the material are described in the last column. In general the torque for the reference sample (without RPI) was around 50%, and for all the compositions containing RPI, the torque was substantially lower, between 35-45%, indicating smoother processing in the melt phase.

### Example 2

### Analysis of Texturized Vegetable Proteins Made by Dry Extrusion

The texturized vegetable protein material made as described in the previous example was characterized using the following methods:

### Density:

A 1000 mL cylinder was tarred, then filled with material at least 15 minutes after production just beyond 1000 mL mark, the cylinder was tapped 10 times at the table, then checked that it was exactly filled to 1000 mL and was weighed again. The measured weight was used as density in g/L.

### Estimate of Particle Size:

Produced material was distributed over checkered paper of 5×5 mm, and photographs were taken after which particle size was determined visually.

### Maximum Water Absorption:

From each sample 50 gram was weighted and to this 150 grams of boiling water was added. It was left to stand for 30 minutes, then the remaining water was manually pressed out and was measured as rest water, by weight. The values are expressed as the amount of water left in the sample per 100 grams dry weight of sample before hydration.

### Firmness of Hydrated Material:

A Texture Analyzer (TA-HD plus, Stable MicroSystems, UK) with a 25 kg load cell was used. A test set up according to the below Table was used.

TABLE
Parameters for TA measurement on hydrated
texturized vegetable protein

| Test mode | Compression | Unit |
|---|---|---|
| Pre-Test speed | 1 | mm/sec |
| Test speed | 1 | mm/sec |
| Post-test speed | 5 | mm/sec |
| Target mode | Strain | |
| Strain | 50 | % |
| Trigger type | Auto force | |
| Trigger force | 0.05 | N |
| Advanced options | Off | |

The target mode was set to Strain 50%. A cup was loaded with 20 g of hydrated texturized vegetable protein and the surface was made as flat as possible with limited impact on the material. After the material was loaded into the cup, a small pre-compression with a strain of 5% was done, to make sure the surface was flat/equal for the final firmness measurement.

The material was hydrated in advance by using twice the amount of hot boiled water compared to the amount of texturized vegetable protein. After addition of the water, the hydrated texturized vegetable protein was left for at least 30 minutes before the measurement was performed. All measurements were performed at least in five-fold. A Tukey-pairwise comparison was performed using the data of the firmness measurements, to be able to group the different products in classes of equal firmness and to analyze which hardness values differ significantly.

All texturized vegetable protein material had a water content of between 4.8 and 9.5%, measured a half hour after production by a moisture analyzer from Mettler Toledo using 3 to 5 grams of material.

The following commercial products were taken along for comparison:
Soy, texturized product based on soy: Arcon TU-218 from ADM
Wheat, texturized product based on wheat: Trutex from MGP Kansas USA
Soy/wheat, texturized product based on both soy and wheat.
Wheat/pea, texturized wheat/pea protein Texta Blé Pois C LT127 from Sotexpro, France
Pea 1, texturized pea protein, Texta Pois 72-90 from Sotexpro, France
Pea 2, texturized pea protein, Texta Pois 55/80 LT126 from Sotexpro, France

Results of these measurements are shown in the below Table.

As is clear from sample series 1-4, addition of RPI to a pea base led to clear processing improvements as well as increased expansion, going from poor, inhomogeneous and relatively small particles with hard, non-expanded pieces in it (sample 1 without RPI) to good and smooth processing with already 10% RPI, and more expansion with increasing RPI concentration. Addition of RPI in the blend also allowed for higher levels of pea fiber. Using a different orifice shape in the die head led to a different shape of products (#7 vs #9): lower density of dry product, but no significant difference in firmness in the hydrated state.

| | | | | | | | | |
|---|---|---|---|---|---|---|---|---|
| | PPI | PF | RPI | Density | Size estimate | Water | Firmness | Tuckey pairwise |
| # | (%) | (%) | (%) | (g/L) | (mm) | absorption | (g) | comparison |

Set 1

| | | | | | | | | |
|---|---|---|---|---|---|---|---|---|
| 1 (Ref) | 80 | 20 | | 394 | 30% < 5 mm | 189.2 | 12458 | A |
| | | | | | 70%~5-10 mm | | | |
| 2 | 70 | 20 | 10 | 228 | 10% < 5 mm | 261 | 5608 | DEF |
| | | | | | 10%~5-10 mm | | | |
| | | | | | 80% > 10 mm | | | |
| 3 | 60 | 20 | 20 | 170 | 10%~5-10 mm | 280 | 5004 | EFG |
| | | | | | 90% > 10 mm | | | |
| 4 | 50 | 20 | 30 | 97 | 100% > 10 mm | 300 | 1865 | J |
| 5 | 50 | 30 | 20 | 226 | 10% < 5 mm | 278 | 5792 | DE |
| | | | | | 90% > 5 mm | | | |

Set 2

| | | | | | | | | |
|---|---|---|---|---|---|---|---|---|
| 6 | 60 | 20 | 20 | 211 | 100% 5-10 mm | 259 | 5073 | EFG |
| 7 | 50 | 30 | 20 | 225 | 10% < 5 mm | 277 | 4247 | FGH |
| | | | | | 90%~5 mm | | | |
| 8 | 55 | 30 | 15 | 244 | 100%~10 mm | 285 | 4989 | EFG |
| 9 | 50 | 30 | 20 | 174 | 100%~10 mm | 292 | 4371 | FGH |

Commercial products

| | | | | | |
|---|---|---|---|---|---|
| Soy | 350 | 10% < 5 mm | 292 | 6571 | BCD |
| | | 90% > 5 mm | | | |
| Pea/wheat | 210 | >80% > 5 mm | | 5396 | DEFG |
| Pea1 | 115 | >55% > 5 mm | | 2712 | IJ |
| Pea2 | | 30-55% > 5 | | 7484 | BC |
| | | 20-40% 3.15-5 | | | |
| | | 10-30% 1-3.15 | | | |
| | | 0-5% < 1 mm | | | |
| Soy/wheat | | | | | DEFG |
| wheat | | | | | FGHI |

### Sensory Testing

A limited set of products was tested in a sensory panel, see below Table. The material was hydrated in vegetable bouillon. Sensory testing was done by using Quantitative Descriptive Analysis (QDA). The trained panel (n=9-13) assessed the extruded products in duplicate taking into account Good Sensory Practices.

During the QDA measurement the intensities of the attributes were obtained by EyeQuestion, using unstructured line scales ranging from 0-100. The products were given one-by-one to the panelists according to a Balanced-Incomplete-Block (BIB) design. The hydrated TVP products were served at 60° C. and given to the panelists in a white polystyrene cup with a white polystyrene spoon.

The data were analyzed using SenPaq. The following data analysis techniques were used:
Principal Component Analysis to generate an overview of the sensory space of the products
Statistically significant product differences were computed by means of ANOVA (Analysis of Variance) for each attribute based on adjusted means for unbalanced data
If a statistically significant product difference occurred, a Multiple Comparison Analysis (Fisher LSD) was computed to investigate which products differed from each other, the mean product score for an attribute followed by different letters are statistically different (p<0.05)

TABLE
Texturized vegetable proteins tested

| # | PPI/PF/RPI |
|---|---|
| 1 (Ref) | 80-20-0 |
| 3 | 60-20-20 |
| 5 | 50-30-20 |
| 7 | 50-30-20 |
| 8 | 55-30-15 |
| Soy/wheat | Soy wheat |

Conclusions were as follows:
The 100% pea (#1) product was the most tough product and needed most force at first bite, followed by soy wheat. They were the least spongy and springy. Sample #3 was also more though on first bite compared to samples #5 and #8.
The products with less pea included (<60% —samples #5 and #7, sample #8 in combination with more fiber were found to be the most cohesive products.
Sample #3 had the most springiness.
Soy/wheat product was most differentiating from the other samples (on aroma & flavor): the product less beany, musty, cereals and least salty. The sample had the least juicy mouthfeel, followed by sample #1 [80/20/0], and had the least meaty and juicy texture.

### Example 3

### Hamburger-Style Demo Product

Model hamburgers were made with texturized vegetable protein variants and egg white as binder. Compositions are given in the Table below.

TABLE
Composition of model hamburgers

| | | | | No-onion |
|---|---|---|---|---|
| | | Full Recipe | | recipe |
| Ingredients | Supplier | Weight (g) | % | % |
| Water | | 41 | 38 | 50 |
| Texturized | See above | 20 | 19 | 25 |
| vegetable | | | | |
| protein | | | | |
| Egg white | Zuidmolen | 4 | 4 | 4 |
| Loribind | Cold swelling starch | 4 | 4 | 4 |
| | from Bobeldijk | | | |
| Salt | | 0 | 0 | 2 |
| Seasoning | Hamburger | 6 | 6 | 6 |
| | seasoning, ZamZam | | | |
| Sunflower | Albert Heijn, | 15 | 14 | 9 |
| oil | the Netherlands | | | |
| Onion | Albert Heijn, | 17 | 16 | 0 |
| pieces | the Netherlands | | | |
| Total | | 107 | 100 | 100 |

All ingredients were mixed together, cold water was added, and the mix was allowed to hydrate for 30 minutes. The dough was formed into a hamburger shape and baked in sunflower oil. The hamburgers were considered fit for consumption when the core temperature was above 72° C. Texturized vegetable proteins used were commercial soy/wheat, commercial wheat only, RPI-comprising samples #7 and #8 from Example 1.

With the above recipe good products could be made, comparable to products found in the market. The different texturized vegetable protein sources gave different textures, the one not necessarily better than the other. The texturized vegetable proteins made with rapeseed protein isolate were highly acceptable without off-flavors.

### Example 4

### Extrudates with Pea Only Compared to Adding RPI or Gluten, and Changes in pH

Extrudates were made using compositions as given in the table below, using the same extruder set up as described in Example 1, now running at 15 kg solids per hour and 2.5 kg water per hour. In two variations, wheat gluten was used instead of rapeseed protein isolate. Furthermore, variants with malic acid or sodium bicarbonate were made to modify the pH.

| Sample name | | | | | Na | Malic |
|---|---|---|---|---|---|---|
| (PPI/PF/RPI) | PPI | PF | RPI | gluten | HCO₃ | acid |
| P80/20/0 | 8 | 20 | | | | |
| P70/30/0 | 70 | 30 | | | | |
| P60/20/20 | 60 | 20 | 20 | | | |
| P50/30/20 | 50 | 30 | 20 | | | |
| P60/20/0/wg20 | 60 | 20 | | 20 | | |
| P50/30/0/wg20 | 50 | 30 | | 20 | | |
| P80/20/0 A | 80 | 20 | | | | 0.5 |
| P60/20/20 A | 60 | 20 | 20 | | | 0.5 |
| P78/20/0 C | 78 | 20 | | | 2 | |
| P58/20/20 C | 58 | 20 | 20 | | 2 | |

The obtained extrudates were analyzed according to the methods described in example 2. Several measurements were done slightly differently:

### Maximum Water Holding Capacity:

The maximum water holding capacity was determined by hydrating material: 30 gram TVP, on 120 gram cold water (1:5), and allowed to hydrate for >1 hr. This 150 gram hydrated material was drained over a sieve and the drained water retrieved was weighed. From this, the maximum water holding capacity in gram of water per gram of TVP was calculated, using the residual water levels by:

[weight drained water+weight water in 30 g TVP]/[dry matter weight of 30 g TVP]

### Particle-Size Analysis:

Particle size distribution was determined by using two sieves, one with square holes of 5.6 mm, one with 1.0 mm, leading to three fractions >5.6 mm; 5.6-1.0 mm; <1.0 mm. At least 30 minutes after production, 100±0.2 gram TVP was brought on the largest sieve. The material was shaken horizontally for 10 seconds, and the weight of the fractions on the various sieves was determined. The <1.0 mm fraction was too small to determine correctly. Most of the <1.0 mm fines were already lost during collection of the material on perforated trays.

### pH Measurement

For the powder: 5 g powder (as used in the extrusion) was dispersed in 5 g 10 mM KCl solution, the samples were left at room temperature and after all powder was hydrated, pH was measured using a PHM220 lab pH meter from Meterlab.

For the hydrated TVP: 2 grams of TVP was hydrated with 2 grams of 10 mM KCl, and then the pH was assessed, by immersing the probe in the hydrated TVP.

The results are presented in the following table.

| | | | | | | | | Water | Firmness |
|---|---|---|---|---|---|---|---|---|---|
| | Water | | | | Particle size | | | holding g | hydrated |
| Sample name | level | density | pH in | pH in | distribution [wt %] | | | water/g | (1:2) by |
| (PPI/PF/RPI) | [%] | (g/L) | powder | TVP | >5.6 mm | 5.6-1.0 mm | <1.0 mm | TVP | TA |
| P80/20/0 | 9.2 | 192 | 7.0 | 7.0 | 77 | 22 | 0 | 2.8 | 4641 |
| P70/30/0 | 9.3 | 211 | 7.1 | 7.0 | 75 | 25 | 0 | 3.5 | 6635 |
| P60/20/20 | 8.8 | 270 | 6.9 | 7.0 | 21 | 79 | 0 | 2.3 | 8245 |
| P50/30/20 | 8.6 | 302 | 6.8 | 6.9 | 15 | 85 | 0 | 2.3 | 6774 |
| P60/20/0/wg20 | 8.7 | 269 | 6.9 | 6.8 | 60 | 40 | 0 | 2.7 | 11844 |
| P50/30/0/wg20 | 9.2 | 366 | 6.8 | 6.7 | 20 | 79 | 1 | 3.2 | 2594* |
| P80/20/0 A | 7.8 | 204 | 6.6 | 6.5 | 65 | 35 | 0 | | 5413 |
| P60/20/20 A | 8.4 | 293 | 6.3 | 6.4 | 23 | 78 | 0 | | 17475 |
| P78/20/0 C | 8.4 | 322 | 8.2 | 8.6 | 50 | 51 | 0 | | 2885* |
| P58/20/20 C | 9.2 | 290 | 7.8 | 8.6 | 40 | 60 | 0 | | 12960 |

*value for firmness suffered from product sticking to the probe and might represent a too low value

The table shows that the pea-only products were the least dense, most expansion, biggest particles (highest fraction<5.6 mm), but this was also due to the highly irregular shape of the particles. After hydration, these particles were made up of firm and hard parts and softer parts, and parts with larger blown-up air bubbles. Upon manual compression or chewing the inhomogeneous character was clear, harder, (too) chewy parts and soft smeary parts.

Upon adding RPI, the particles became more uniform, spherical, denser and smaller. These were also firmer after hydration and in manipulation (manual, mouth) and evenly chewy. This material compared well to the textural perception of commercial minced meat (Vivera minced, see https://vivera.com/product/vivera-plant-mince/).

Gluten addition led to inhomogeneous material, and even denser. In character the hydrated material behaved roughly between the pea-only and the pea-RPI product, although it was much firmer. The inhomogeneous character could also be sensed manually or orally.

The addition of Pea Fiber led to slightly denser products—less expansion over the whole range. The firmness of the hydrated material increased for the pea-only with more fiber. Still the hydrated material easily turned into more smeary paste upon pressure (by fingers or spoon), which could also be observed orally.

For pea-RPI or pea-gluten, more fiber led to lower firmness after hydration. The pea-gluten TVP with 30% fiber gave small particles that upon hydration were soft and smeary.

The maximum water holding capacity for pea-only was higher than when RPI was added—with gluten in between. Addition of more pea fiber did not change the water holding value for the pea-RPI TVP product, whereas for pea-only and pea-gluten, more fiber leads to more water holding.

Noteworthy is that in some cases the drained water from pea-only or pea-gluten TVPs was turbid, and in the products containing CanolaPRO, the drained water was nearly clear.

The extrusion process in the presence of RPI was much smoother: the pressure fluctuated far less with RPI present than with pea-only. Gluten was in between.

Role of modification of the pH. By addition of 0.5% malic acid to the powder mix reduced the pH of a hydrated premix from around 7.0 to 6.6/6.3, and of the hydrated TVP also to from 7.0 to around 6.5. Addition of 2% sodium bicarbonate increased the pH of the hydrated premix to around 8, and of the hydrated TVP even to 8.6.

Changing the pH led to TVPs with different appearance: at lower pH the hydrated TVP products seemed to become lighter, with higher pH these were darker. The differences in mechanical properties can be derived from the values in the table above: for pea-only, the density goes up for the higher pH. For the pea-RPI product the differences in density were small. After hydration however, the RPI-containing TVPs were substantially harder than the product without pH modification. This can also be sensed by compression between the fingers and orally. The hardness of pea-only TVPs was hardly affected by changing the pH, although the firmness of 78/20/0 C (pea with bicarbonate) was found much lower, but that was likely due to material sticking to the probe, resulting in a far too low value. The particle size distributions showed little variation, except for the acidic pea-only TVP that had larger fraction of smaller particles than the neutral pea-only TVP.

In conclusion: Adding RPI to pea-based TVP improved the textural properties, product homogeneity, and processing stability. Addition of gluten also improved compared to pea-only, but not by the extent that RPI does. And upon hydration, the gluten-containing material was highly inhomogeneous and had smeary parts. Addition of RPI also allowed for larger variation in base composition: addition of higher pea fiber levels was possible without harming the texture. Varying the pH in the premix by adding acid or caustic changed the properties of TVPs, in texture and appearance. The impact on firmness of the hydrated product was largest for the pea-RPI variants.

### Example 5

### Impact of Water Level During Extrusion in Pea-Only and Pea-RPI Extrudates

The water level during extrusion is an important parameter to steer the final mechanical properties of the TVPs. Similar compositions as described in example 4 were processed, with a dry matter to water ratio (DM:W) of 6:1, and 4:1 or 3:1. After production, the products with a higher water level were further dried in an oven [at least 20 min at 47° C.]. The product characteristics are given in the table below. More water led to less expansion and thus higher density and smaller particles,

Remarkably, the firmness after hydration decreased for the pea-only and the pea-RPI combination. Under compression the difference between with or without RPI remained as seen in the previous example: the hydrated pea-only TVP processed with higher water level became mushy, whereas the pea-RPI product remained resilient.

| | | | | | | Firmness |
|---|---|---|---|---|---|---|
| Sample name | Water | density | Particle size distribution [wt %] | | | hydrated |
| (PPI/PF/RPI) | level [%] | (g/L) | >5.6 mm | 5.6-1.0 mm | <1.0 mm | (1:2) by TA |
| P80/20/0 II 6:1 | 8.9 | 144 | 82 | 19 | 0 | 8057 |
| P80/20/0 II 4:1 | 10.4 | 415 | 14 | 86 | 0 | 3052 |
| P60/20/20 II 6:1 | 8.7 | 222 | 35 | 65 | 0 | 4517 |
| P60/20/20 II 4:1 | 10.5 | 369 | 5 | 95 | 1 | 3537 |
| P60/20/20 II 3:1 | nm | 422 | 2 | 98 | 0 | nm |

nm = not measured

Conclusion: By variation of the water level during extrusion, the properties of the TVP could be changed: expansion decreased upon increasing the water level. The tolerance for varying water level in the presence of RPI was however better, the material retained its elastic and firm nature with higher water level.

### Example 6

### Impact of RPI on Extrudates Made with Fava Bean or Lupin

Dry extrudates were made from other legume sources: fava bean flour (51% protein, 22% carbohydrate of which a large fraction starch, the ingredient was heat treated), and lupin isolate (91% protein), using conditions as described in example 4. These materials behaved differently compared to pea-based products. Generally, the processing went quite smooth, the pressure was relatively low, mostly below 30 bar. Particularly these products (processed with dry matter to water ratio DM:W=6:1) expanded highly, leading to large fluffy spherical objects—smooth balls, like chickpeas.

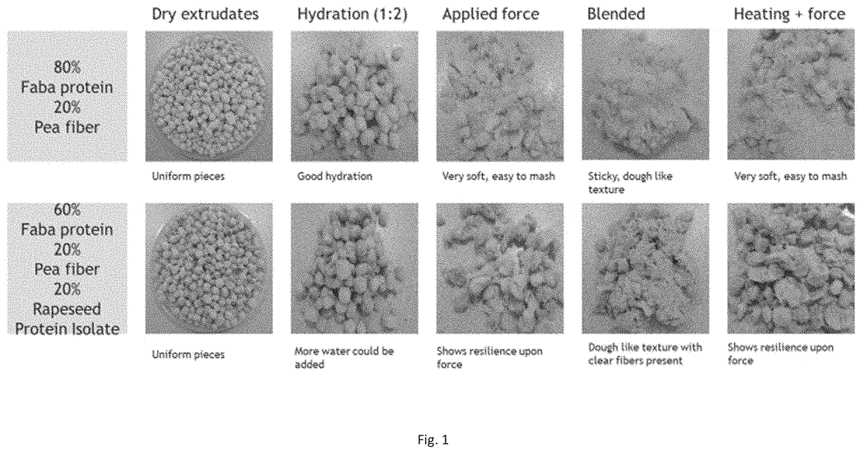

In FIG. 1 the impact of hydration and subsequent heating, and compression of the fava bean products is shown, illustrating that the presence of RPI made products more resistant to mechanical forces such as chewing and processing into a meat alternative end product. This was confirmed orally. The same effect was seen for the lupin-based products: with RPI more resilient and elastic texture.

The product characteristics were also reflected in the measured properties as shown in the table below. It shows that the densities of the products were low, for the lupin-based products very low, also represented by the large fraction of particles larger than 5.6 mm, For the lupin-only extrudate nearly all particles were larger than 5.6 mm, most were between 10-20 mm. The firmness of the hydrated product was also low. The hydrated product without RPI was squeezed into a mushy mass, whereas the products with RPI kept their structural integrity upon manual compression. Upon chewing of the hydrated material, this difference was also clear: The lupin-only product was soft and fell apart in the mouth, whereas with RPI present, the material had resilience and bit of bite.

| | | | | | | | | Water | Firmness |
|---|---|---|---|---|---|---|---|---|---|
| Sample name | Water | | | | | | | holding g | hydrated |
| (F or L/PI/RPI) | level | density | pH in | pH in | Particle size distribution [wt %] | | | water/g | (1:2) by |
| [DM:W if not 6:1] | [%] | (g/L) | powder | TVP | >5.6 mm | 5.6-1.0 mm | <1.0 mm | TVP | TA |
| F80/20/0 | 9.0 | 194 | 6.4 | 6.3 | 58 | 42 | 0 | 4.2 | 2118 |
| F60/20/20 | 8.4 | 166 | 6.4 | 6.4 | 68 | 33 | 0 | 4.0 | 2374 |
| F50/30/20 | 8.4 | 149 | 6.3 | 6.3 | 83 | 18 | 0 | 3.8 | 1924 |
| L80/20/0 | 9.4 | 53 | 7.2 | 6.6 | 97 | 3 | 0 | 3.8 | 880 |
| L60/20/20 | 9.0 | 59 | 7.0 | 6.6 | 95 | 6 | 0 | 3.3 | 773 |
| L60/20/20 [7-5:1] | 7.4 | 49 | | 6.6 | 100 | 0 | 0 | 3.6 | 1198 |
| L60/20/20 [4:1] | 11.1 | 375 | | 6.4 | 15 | 85 | 0 | 2.5 | 3834 |

* value for firmness suffered from product sticking to the probe and might represent a too low value

In one variation the water level in the lupin-RPI composition (L60/20/20) was varied: lower (DM:W 7/5:1) and higher (DM:W 4:1). It clearly showed that increasing the water fraction (L60/20/20 4:1) led to extrudates with higher density and smaller particles, and higher firmness upon hydration, all properties more comparable to what was seen for pea-RPI extrudates, especially P60/20/20—see example 4. Also, during processing the pressure increased with a higher water level to levels that are usually seen for well processed extrudates. After hydration, this L60/20/20 4:1 extrudate showed more resistance to pressure. This product obtained a lighter appearance than those processed with less water.

The maximum water holding capacity was for all fava bean and lupin products high. The water could be pressed out of the material. However, the L60/20/20 4:1 product had equal water holding capacity as P60/20/20.

The pH of the fava bean premix powders and TVP products was lower than for the pea-based products, Varying the pH in the premix as explained in example 4 may well be a method to manipulate the hydration and expansion of the products and hence the overall product properties.

Conclusion: TVPs made from fava bean protein or lupin protein with RPI were qualitatively better as seen by a more resilient product after hydration. Expansion was too high for these products, however addition of more water during extrusion could improve this: the properties of L60/20/20 4:1 (DM:W) were nearly the same as the P60/20/20 [6:1].

### Example 7

### Nutritional Value

The PDCAAS was calculated for PPI/PF/RPI combinations. Pea is deficient in tryptophan and that determines the overall PDCAAS value. Pea fiber contains only a low amount of protein, this was not taken into account in the calculation.

| Composition | Calculated |
|---|---|
| PPI/PF/RPI | PDCAAS |
| 80/20/0 | 0.78 |
| 60/20/20 | 0.89 |
| 50/30/20 | 0.91 |
| 55/30/15 | 0.88 |

From the table it is clear that by addition of RPI to an extrudate containing pea protein isolate, the PDCAAS increases substantially, getting closer to the maximum value of 1.

1. A process for preparing a texturized vegetable protein comprising:
(a) mixing rapeseed protein, legume-derived protein, plant-based fiber and from 5 30% (w/w) water in an extruder,
(b) heating the mixture obtained in (a) to a temperature of from 100 180° C.,
(c) extruding the mixture obtained in (b) through an extrusion die.

2. The process according to claim 1 wherein the product extruded in (c) is cut in particles at a cutting speed of from 100-3000 rpm.

3. The process according to claim 1, wherein the legume-derived protein is chosen from the group consisting of pea protein, fava bean protein and lupin protein.

4. The process according to claim 1 wherein said legume-derived protein is pea-derived protein and/or wherein said plant-based fiber is pea fiber.

5. The process according to claim 1 wherein said rapeseed protein is rapeseed protein isolate and/or rapeseed protein concentrate and/or wherein said legume-derived protein is legume-derived protein isolate and/or legume-derived protein concentrate or legume-derived protein enriched flour.

6. The process according to claim 1 wherein the amount of water in (b) is from 10 30% (w/w).

7. A composition comprising rapeseed protein isolate and/or rapeseed protein concentrate and legume-derived protein isolate and/or legume-derived protein concentrate and plant-based fiber.

8. The composition according to claim 7, wherein said legume-derived protein is chosen from the group consisting of pea protein, fava protein and lupin protein and/or wherein said plant-based fiber is pea fiber.

9. The composition according to claim 7 whereby 95% of said particles have a size of between 1-80 mm.

10. The composition according to claim 7 comprising 0.1 5.5% (w/w) of sodium chloride.

11. A product according to claim 7 in a preparation of a meat alternative.

12. The product according to claim 11 wherein said meat alternative is a beef-like patty, a nugget, (“meat”) balls, minced-style products, (stir-fry) pieces, a sauce or a sausage.

13. The meat alternative comprising the composition of claim 7.

14. The meat alternative according to claim 13 which is a beef-like patty, a nugget, (“meat”) balls, minced-style products, (stir-fry) pieces, a sauce or a sausage.

15. A Meat alternative according to claim 13 which comprises less than 20 ppm gluten and/or less than 10 ppm gliadin and/or does not contain animal-derived material.
